(19) United States
(12) Patent Application Publication
(10) Pub. No.: US 2012/0076416 A1
(43) Pub. Date: Mar. 29, 2012

(54) DETERMINING CORRELATIONS BETWEEN SLOW STREAM AND FAST STREAM INFORMATION

(76) Inventors: Maria G. Castellanos, Sunnyvale, CA (US); Chetan Kumar Gupta, Austin, TX (US); Song Wang, Auston, TX (US); Umeshwar Dayal, Satatoga, CA (US)

(21) Appl. No.: 12/889,805

(22) Filed: Sep. 24, 2010

(51) Int. Cl. G06K 9/46

(52) U.S. Cl. 382/190; 382/218

(57) ABSTRACT

A collection of documents are correlated with information items in a fast stream of information using categorical hierarchical neighborhood trees (C-HNTs). First data entities extracted from the documents are inserted into corresponding C-HNTs. The first data entities that are neighbors in the C-HNTs of second data entities extracted from the fast stream items are identified. Similarities between the documents and the fast stream items are determined based on the location at which the neighbors are located.

### BACKGROUND

In today's world, an overwhelming amount of current and historical information is available at one's fingertips. For instance, social media, such as news feeds, tweets and blogs, provide the opportunity to instantly inform users of current events. Data warehouses, such as enterprise data warehouses (EDWs), maintain a vast variety of existing or historical information that is relevant to the internal operations of a business, for example. However, despite this wealth of readily available information, a typical business enterprise generally lacks the capability to extract valuable information from external sources in a manner that allows the business to readily evaluate the impact current events may have on the business' operations and objectives.

### BRIEF DESCRIPTION OF THE DRAWINGS

Some embodiments are described with respect to the following figures:

FIG. 1 is a flow diagram of an exemplary technique for correlating fast and slow stream information to determine similarities, in accordance with an embodiment.

FIG. 2 is a block diagram of an exemplary high level architecture for implementing the technique of FIG. 1, in accordance with an embodiment.

FIG. 3 is a figurative illustration of the exemplary technique of FIG. 1, in accordance with an embodiment.

FIG. 4 is a flow diagram of a portion of the exemplary correlation technique of FIG. 1, in accordance with an embodiment.

FIG. 5 is a diagram of an exemplary hierarchical neighborhood tree, in accordance with an embodiment.

FIG. 6 illustrates an exemplary implementation in which neighbors of a news items are identified, in accordance with an embodiment.

FIG. 7 illustrates an exemplary technique for identifying a top k list, in accordance with an embodiment.

FIG. 8 illustrates another exemplary technique for identifying a top k list, in accordance with an embodiment.

FIG. 9 is a block diagram of an exemplary architecture in which the technique of FIG. 1 may be implemented, in accordance with an embodiment.

### DETAILED DESCRIPTION

Competitive business advantages may be attained by correlating existing or historical data with real-time or near-real-time streaming data in a timely manner. An example of such commercial advantages may be seen by considering large business enterprises that have thousands of customers and partners all over the world and a myriad of existing contracts of a variety of types with these customers and partners. This example presents the problem of lack of situational awareness. That is, businesses generally have not used data buried in the legalese of contracts to make business decisions in response to the occurrence of world events that may affect contractual relationships. For instance, current political instability in a country, significant fluctuations in currency values, changes in commercial law, mergers and acquisitions, and a natural disaster in a region all may affect a contractual relationship.

Timely awareness of such events and the contractual relationships that they affect may provide the opportunity to quickly take responsive actions. For example, if a typhoon occurs in the Pacific region where an enterprise has its main suppliers, the ability to extract and correlate this information from news feeds and correlate it with the suppliers' contracts in near real time could alert business managers of a situation that may affect the business operations that depend on those suppliers. Manually correlating news feeds with contracts would not only be complex, but practically unfeasible due both to the vast amount of information (both historical and current) and the rate at which current information is generated and made available (e.g., streamed) to users.

Accordingly, embodiments of the invention described herein exploit relevant fast streaming information from an external source (e.g., the Internet) by correlating it to internal (historical or existing) data sources to alert users (e.g., business managers) of situations that can potentially affect their business. In accordance with exemplary embodiments, relevant data can be extracted from disparate sources of information, including sources of unstructured data. In some embodiments, a first source may be a relatively slow stream of information (e.g., a collection of stored historical or recently generated documents), while a second source of information may be a fast stream of items (e.g., RSS feeds with news articles). Extracted elements from one of the streams may be correlated with extracted elements from the other stream to identify items in one stream that have an affect on items in the other stream. For example, current events extracted from a fast stream of news articles may be correlated with contractual terms extracted from contracts in a business' document repository. In this manner, a business manager may be alerted to news articles reporting current events that may affect performance of one or more of the contracts.

Some implementations also may perform an inner correlation on the data extracted from the fast streams to evaluate the reliability of the information. As an example, for news streams, the more news articles report on a given event, the higher the likelihood that the event actually occurred. Consequently, as the news streams are processed, implementations of the invention may update or refine the correlations between extracted elements with a reliability score that is determined based on the inner correlation.

While the foregoing examples have been described with respect to providing situational awareness in a contracts scenario for a business enterprise, it should be understood that the examples are illustrative and have been provided only to facilitate an understanding of the various features of the invention that will be described in further detail below. Although the foregoing and following examples are described in terms of a fast stream of news articles and a slow stream of contracts, it should be understood that the fast stream could contain other types of current information and that the slow stream could include other types of existing information. It should be further understood that illustrative embodiments of the techniques and systems described herein may be implemented in applications other than a contracts scenario and in environments other than business enterprises.

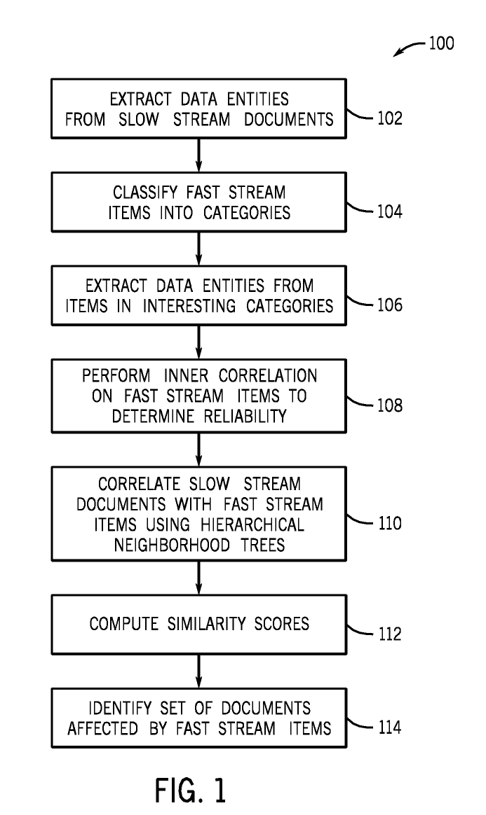

Turning first to FIG. 1, a flow diagram is shown of an exemplary technique 100 for extracting relevant data from two disparate sources of information (e.g., a fast stream of real-time or near-real-time information and a slow stream of previously existing information) and correlating the extracted data determine those items of existing information that are affected by the real-time information. In this manner, situational awareness may be attained.

At block 102, relevant data is extracted from a slow stream of documents. Here, a slow stream may include stored historical documents (e.g., legacy contracts), as well as new documents (e.g., newly executed contracts) that are stored in a document repository, for instance. The documents in the collection may be viewed as static information. That is, while the collection itself may change as new documents are added, the content of the documents is generally fixed. The data extracted from the slow stream of documents constitutes the seeds for a subsequent search for relevant items in the fast stream (e.g., news articles that may affect contractual relationships). For example, the data extracted from a contract in the slow stream could include the other party's company name, the expiration date of the contract and the country of the other party's location. Events can then be extracted from the fast stream that may be correlated with the extracted slow stream data, such as natural disasters and currency fluctuations in the other party's country, business acquisitions mentioning the other party's company name, etc.

In exemplary implementations, the slow stream extraction task may not simply entail recognizing company names, dates or country names. Rather, the data extraction may be performed using role-based entity recognition. That is, from all the dates in the contract, only the date corresponding to the contract's expiration is extracted, and from all the references to company names (e.g., a contract may mention companies other than the other party), only the other party's company name is extracted.

In some embodiments, before relevant data is extracted from the fast stream, items (e.g., news articles) from the fast stream (e.g., New York Times RSS feeds) are classified into predefined interesting categories (e.g., natural disasters, political instability, currency fluctuation) (block 104). In some embodiments, a single non-interesting category also may be provided, and all irrelevant articles may be classified into the non-interesting category. At block 106, relevant data from the items in the interesting categories is extracted. For example, in the interesting category for natural disasters, the relevant data may include the disaster event (e.g., a typhoon) and the region in which the event occurred (e.g., the Pacific). Items in the non-interesting category may be ignored.

At block 108, the technique 100 may then perform inner correlations between the currently extracted fast stream data and fast stream data that was previously extracted within a specified previous time window of the fast stream. In exemplary embodiments, descriptor tags can be created that correspond to the data extracted from the articles in the interesting categories, and the inner correlation may be performed by correlating the current tags and previous tags. These inner correlations may then be used to derive reliability scores that are indicative of the accuracy and/or reliability of the extracted data. At block 110, the technique 100 then measures similarity between the slow stream documents and the fast stream interesting items.

In exemplary embodiments, and as will be explained in further detail below, at block 110, similarity is measured using the extracted slow stream and fast stream data (or their corresponding tags) as “features” and then extending those features along predefined hierarchies. Similarity can then be computed in terms of hierarchical neighbors using fast streaming data structures referred to herein as Categorical Hierarchical Neighborhood Trees (C-HNTs). The hierarchical neighborhoods defined by the C-HNTs are used to find and measure the strength of correlations between the slow stream documents and the fast stream items using categorical data. The stronger (or tighter) the correlation, the greater the similarity between items and documents. Based on this measure of similarity, a set of existing documents that may be most affected by the current event(s) reported in the news article(s) can be identified.

As an illustrative example, assume a contract does not mention Mexico by name but is negotiated in Mexican pesos, and assume a news article reports a hurricane in the Gulf of Mexico. In this example, the term “peso” belongs to a predefined hierarchy (e.g., a “location” hierarchy) where one of its ancestors is “Mexico.” Similarly, the “Gulf of Mexico” also belongs to the “location” hierarchy and “Mexico” also is an ancestor. Thus, the contract and the news article are neighbors in the “location” hierarchy at the level of “Mexico” and are related through the common ancestor “Mexico.”

Once correlations are obtained using the C-HNTs, similarity scores can be derived (block 112). In some embodiments, the relevance scores may factor in the reliability scores computed before. The relevance scores may then be used to identify those documents in the slow stream that may be affected by the information in the fast stream (e.g., contracts that are affected (or most affected) by events reported in the news articles) (block 114).

The technique illustrated in FIG. 1 generally may be implemented in three phases. In exemplary embodiments, the first phase is performed off-line and is specific to the particular domain in which the technique 100 is being implemented. In general, the first phase involves learning models for extracting data from the streams and for classifying information carried in the fast stream. In some embodiments, to prepare for the model learning phase, a preliminary specification step is performed in which a user defines (e.g., using a graphical user interface (GUI)) the types of entities to extract from the information streams, as well as other domain-specific information (e.g., types of interesting categories). In the second phase, the models learned in the first phase are applied to classify items in the fast stream and to extract relevant data therefrom, as well as to extract relevant data from the slow stream documents. These tasks can be performed off-line (e.g., for documents already stored in a collection) or on-line for slow (e.g., new documents being added to the collection) or fast (e.g., news feed) streams of information. In the third phase, analytics are applied to determine correlations between the fast stream and slow stream items and, based on the correlations, to identify a set of slow stream items that may be most affected by the fast stream information.

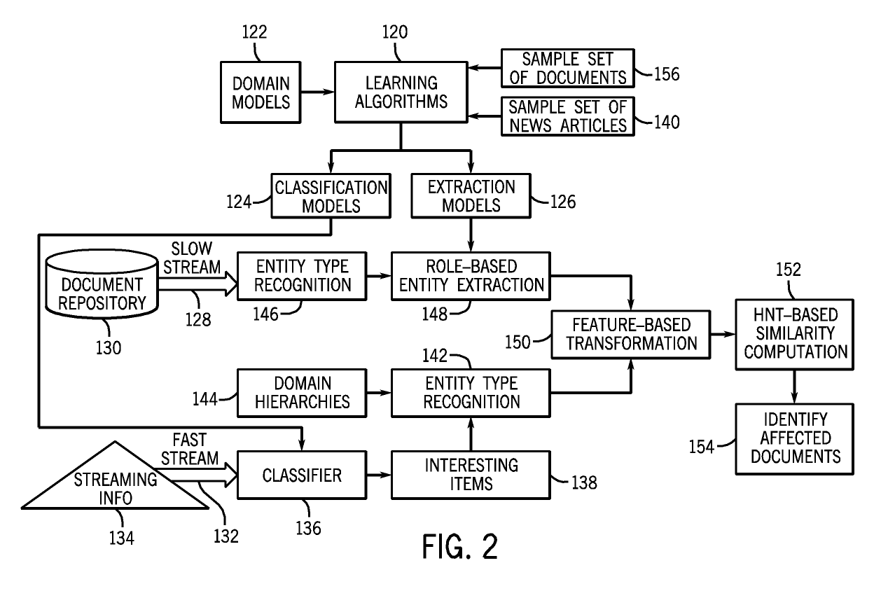

Referring now to FIG. 2, a high level block diagram of the functional components of the technique 100 shown in FIG. 1 is provided. Prior to the learning phase, domain-specific models 122 are provided which define domain-specific information, such as the types of entities to be extracted, categories of interesting information, etc., and which are used during the learning phase. As a result of the learning phase, classification models 124 for classifying items in the fast stream are learned and extraction models 126 for extracting role-based entities from the slow stream are learned using learning algorithms 120. These classification and data extraction models 124 and 126 are then applied during the application phase to fast stream 132 and slow stream 128, respectively. The classification models 124 are used by a classifier 136 to classify items into interesting categories 138.

In an exemplary embodiment, the classifier 136 can be an open source Support Vector Machine (SVM)-based classifier that is trained on a sample set of tagged news articles 140 can be used for classification of items in the fast stream 132. In such an embodiment, and in other embodiments which implement text classification, stop words are eliminated and stemming is applied beforehand. Bi-normal separation may be used to enhance feature extraction and improve performance.

Following classification, an entity-type recognition algorithm 142 can be used to extract relevant data from the items in the interesting categories 138. For instance, as shown in FIG. 2, predefined domain hierarchies 144 that correspond to the interesting categories are used by the entity-type recognition algorithm 142 to detect and extract relevant data from the interesting items 138. Examples of recognition algorithms will be described below.

In the exemplary implementation shown in FIG. 2, an entity-type recognition algorithm 146 also is applied to the slow stream 128 documents to extract plain entity types. In some embodiments, the extracted data may be refined by applying a role-based entity extraction algorithm 148 to the extracted plain entities. Examples of role-based entity extraction algorithms will be described below. As also will be explained in further detail below, based on the extracted entities, a feature-based transformation 150 is performed on the slow stream 128 documents and the fast stream 132 items, wherein the features correspond to the extracted entity types and the transformation results in a feature vector. Analytics 152 are then applied to the feature vectors to correlate documents and items using categorical data structures (i.e., the C-HNTs). The output of the analytics 152 is a similarity computation (e.g., similarity scores) that may then be used to identify those slow stream 128 documents that are affected by the information in the fast stream 132 (block 154).

For instance, in an illustrative embodiment, the data is extracted from the streams of information in terms of “concepts” (i.e., semantic entities). Each concept belongs to a concept hierarchy. An example of a concept hierarchy is a “location” hierarchy. A C-HNT is a tree-based structure that represents these hierarchies. In the illustrative implementation, each document in the slow stream is converted to a feature vector where every feature of the vector is one of the extracted concepts. As a result, each document can be coded as a multidimensional point that can be inserted into the corresponding C-HNTs.

To further illustrate: assume a contract contains the concept “toner” and the concept “Mexico.” The contract can then be transformed into a two-dimensional vector, where “toner” belongs to a “printer” hierarchy and “Mexico” belongs to a “country” hierarchy. In other words, for the dimension “printer,” the value is “toner”; and for the dimension “country,” the value is “Mexico.” As a result of this transformation process, the contracts in the slow stream can be stored as multidimensional points in the C-HNTs. Likewise, an “interesting” news article can be converted to a multidimensional point and inserted into the C-HNTs. The contracts in each level of the C-HNT corresponding to each of the dimensions of the multidimensional point representing the news article are the neighbors of the news item. For example, if a news article contains the concept “Honduras,” then a contract containing the concept “Mexico” is a neighbor of the news article at the level of “Political Region” in the “country” dimension.

Further details of exemplary implementations of the main components of the architecture in FIG. 2 are provided below. These components are further discussed in terms of a model learning phase, a model application phase, and a streaming analytics phase.

Model Learning Phase. In an illustrative implementation of the model learning phase, models 124 and 126 for classifying fast stream items (e.g., news articles, etc.) and for extracting relevant data from the classified fast stream items 132 and the slow stream 128 documents are learned offline using supervised learning algorithms. To this end, the user first provides domain knowledge in the form of domain models 122 that the model learning algorithm 120 uses during training in the learning phase. In an exemplary implementation, the domain knowledge is provided once per domain and is facilitated through a graphical user interface (GUI) that allows the user to tag a sample of text items (e.g., articles, etc.) with their corresponding categories and relevant data. For instance, the GUI may allow the user to drag and drop the text items into appropriate categories and to drag and drop pieces of text contained within the items into appropriate entity types. To facilitate this task, a set of interesting categories and relevant role-based entity types may be predefined.

To illustrate, in the contracts scenario, the user performs various tasks to provide the domain knowledge. In one embodiment, these tasks begin with specification of the categories of news articles that may impact contractual relationships. These categories are referred to as “interesting categories.” In this scenario, an example of an interesting category may be “natural disasters.” For instance, if an enterprise has contracts with suppliers in the Philippines, then if a typhoon in the Pacific affects the Philippines, the contractual relationships with those suppliers might be affected, e.g., the typhoon likely would affect the suppliers' timely delivery of products in accordance with the terms of the contracts. For those articles that bear no relevance to contractual relationships (e.g., an article that reports on a sports event), a generic “uninteresting category” may be included by default.

Once categories are specified, then a sample set of items/documents 156 can be annotated with corresponding categories. In an illustrative implementation, the sample set 156 has ample coverage over all of the interesting categories, as well as the generic non-interesting category. This annotated set may then be used for training the model learning algorithm 120 to produce models 124 that will classify the items in the fast stream 132.

Relevant data to be extracted from items/documents in the slow and fast streams 128, 132 also can be defined by the user during this phase. Company name, catastrophe type, date, region, etc. are examples of types of data that may be relevant. In an exemplary implementation, relevant data is divided into “entity types.” In some embodiments, a predefined set of common entity types may be available to the user for selecting those that are applicable to the particular domain. The predefined set also may be extended to include new entity types that are defined by the user.

In some embodiments, a distinction may be made between the types of data extracted from the fast stream 132 of current information and the types of data extracted from the slow stream 128 of documents. In such embodiments, “plain entity types” may be extracted from the items in the fast stream 132, while “role-based entity types” may be extracted from the items in the slow stream 128. For instance, in the contracts scenario, the company name of the other party, its location, the contract expiration date and the contract object may be useful information to identify world events that might affect contractual relationships. For example, the other party's company name can be used to identify news articles that mention the company. The other party's company's location helps to identify news articles involving geographical areas that contain the location. The contract expiration date can be useful to identify news that becomes more relevant as the contract expiration date approaches. The contract object can be used to identify news about related objects (e.g., products). These types of data are “role-based” because they depend upon the particular context or role in which the data is used. For instance, not all company names that appear in the contract are of interest. Instead, only the company name of the contracting party is relevant. Similarly, not all dates in the contract may be relevant, and the user may be interested in only extracting the contract expiration date.

As with the plain entity types, a set of role-based entity types may be predefined and presented to the user for selection. Alternatively, or in addition to the predefined set, the user may also define new role-based entity types.

In exemplary embodiments, the model learning phase concludes with the user tagging role-based entity instances in the sample set 156 of slow stream documents (e.g., contracts). In one embodiment, the user may drag and drop instances in the sample set 156 into the corresponding role-based entity types available on the GUI. The tagged documents may then be used as a training set to learn the extraction models 126 for the slow stream 128.

In the exemplary contract scenario described herein, the extraction models 126 are trained to recognize the textual context in order to extract the role-based entities. The context of an entity is given by the words surrounding it within a window of a given length. In some embodiments, this length may be set to ten words, although shorter or longer lengths also may be selected depending upon the particular scenario in which the extraction models are implemented and the extraction technique used. The extraction models 126 may be based on any of a variety of known context extraction techniques, such as HMM (Hidden Markov Model), rule expansion, and genetic algorithms. Again, the selection of a particular extraction technique may depend on the particular domain and type of document from which data is being extracted.

As an example, for contract-type documents, a genetic algorithm may be best suited to extract role-based entities. In such embodiments, the genetic algorithm can be used to learn the most relevant combinations of prefixes and suffixes from the context of tagged instances of a role-based entity type of interest. These combinations can be used to recognize the occurrence of an instance of the given type in a contract. To this end, a bag of terms can be built from all the prefixes in the context of the tagged entities in the training set. Another bag can be built from their suffixes.

To illustrate, consider the tagged sentence:
due to expire <expirationDate> Dec. 31, 2006, </expirationDate> is hereby terminated
   The terms “due”, “to”, “expire” are added to a bag of prefixes of the role-based entity type “expirationDate” whereas the terms “is”, “hereby”, “terminated” are added to its bag of suffixes. The bags can then be used to build individuals with N random prefixes and M random suffixes in the first generation and for injecting randomness in the off-springs in later generations. Since only the best individuals of each generation survive, the fitness of an individual is computed from the number of its terms (i.e., prefixes and suffixes) that match the context terms of the tagged instances. The best individual in a pre-determined number of iterations represents a context pattern given by its terms and is used to derive an extraction rule that recognizes entities of the corresponding type. The genetic algorithm is run iteratively to obtain more extraction rules corresponding to other context patterns. The process ends after a given number of iterations or when the fitness of the new best individual is lower than a given threshold. The rules may be validated against a previously unseen testing set and those rules with the highest accuracy (i.e., above a give threshold) constitute the final rule set for the given role-based entity type.

In exemplary embodiments, the extraction models 126, such as the genetic algorithm model just described, may be flexible in that they allow creation of individuals that do not necessarily have N prefixes and M suffixes. The artifact used for this purpose is the empty string as an element in the bags of prefixes and suffixes. The extraction models 126 also may be capable of using parts-of-speech (PoS) when PoS tags are associated to terms. In such embodiments, a PoS tagger, such as a readily available open source PoS tagger, can be used in a pre-processing step and extraction models can be built for the PoS-tagged version of the training set and for the non-PoS tagged version. The version that yields the best results determines whether PoS tagging is useful or not for the given document set. PoS tagging can be a costly task and a model that uses PoS tags requires to tag not only the training set but also the production set on which it is applied (regardless whether the production set is static or streaming). Nonetheless, PoS can be particularly useful for role-based entity extraction performed on the slow stream (i.e., contracts).

In an exemplary embodiment, plain (i.e., non-role-based) entities can be extracted from the fast stream of information using an entity recognizer 142, such as a readily available open source recognizer (e.g., GATE (General Architecture for Text Engineering)) or a readily available web services entity recognizer (e.g., OpenCalais), and/or by building a specific entity recognizer, such as manually created regular expressions, look-up lists, machine learning techniques, etc. In some embodiments, the association of entity recognizers to the relevant entity types may be done at the same time that the entity types are specified during the domain specification process. For instance, the GUI may display a menu of predefined recognizers, and the user may drag and drop a specified entity type into the corresponding recognizer box.

In some embodiments, additional entity types may be inferred because they are related to those that have been specifically defined by the user. For example, the user may have indicated that “country” is a relevant entity type of interest. As a result, “region” may be an inferred relevant entity type because an event that takes place in a region will also affect the countries in that region. As another example, if a user had indicated that “company” is a relevant entity type, “holding” and “consortium” may be inferred relevant entity types because an event that affects a consortium also affects its company members.

In exemplary implementations, and as will be explained in further detail below, relevant entity types may be inferred through the use of hierarchies. In this way, once an entity type is specified by a user, hierarchies may be traversed to infer relevant related entity types which may then be presented to the user. The user may then associate the inferred entity types with the appropriate entity recognizers in the same manner as previously described with respect to the user-specified entity types.

Model Application Phase. In illustrative implementations, once the classification and extraction models 124, 126 have been built during the off-line learning phase, the models 124, 126 are available for on-line classification and information extraction on the fast and slow streams 132, 128 of information. In some embodiments, for the slow-stream information 128, the extraction models 124 may be applied during both the off-line phase on historical data, as well as during the on-line phase on new information (e.g., new contracts).

In an exemplary implementation, the application of the extraction models 126 to the slow stream 128 of documents information may be performed by first applying plain entity recognizers 146, such as GATE or OpenCalais. For example, if a model 126 is configured to extract expiration dates, a date entity recognizer 146 may be applied to identify all the dates in a contract. Once the dates are identified, then an expiration date extraction model 126 can be used by the role-based entity extraction algorithm 148 to the context of each recognized date. Applying the extraction models 126 in this manner may eliminate any need to apply the models 126 on the entire contract (such as by using a sliding window) and may improve the overall accuracy of the extraction. The data extracted in the form of entities can then be assembled into tag descriptors to be processed by streaming analytics, as will be explained in further detail below.

With respect to the fast stream 132 of information, each item first is classified into the interesting categories or the uninteresting category using the classification model 124 and classifier 136. If the article falls into an interesting category, then the entity recognizers 142 corresponding to the entity types that are relevant to that category (both the user specified and the inferred entity types) are applied to extract information. Here again, the information in the form of entities is assembled into tag descriptors.

In some embodiments, classification and information extraction on the fast stream 132 of information may use a multi-parallel processing architecture so that different classifiers 136 and entity recognizers 142 may be applied in parallel on a particular item in the fast stream. Such an architecture may also allow different stages of the classifier 136 and recognizer 142 to be applied concurrently to multiple articles.

Streaming Analytics Phase. In exemplary embodiments, the streaming analytics phase finds correlations between the slow stream 128 documents (e.g., contracts) and the fast stream 132 items (e.g., news articles). This correlation is based on the extracted semantic entities, which will be referred to as “tags” in the streaming analytics context. The tags are obtained in the model application phase described above and, as will be described below, will be used for C-HNTs.

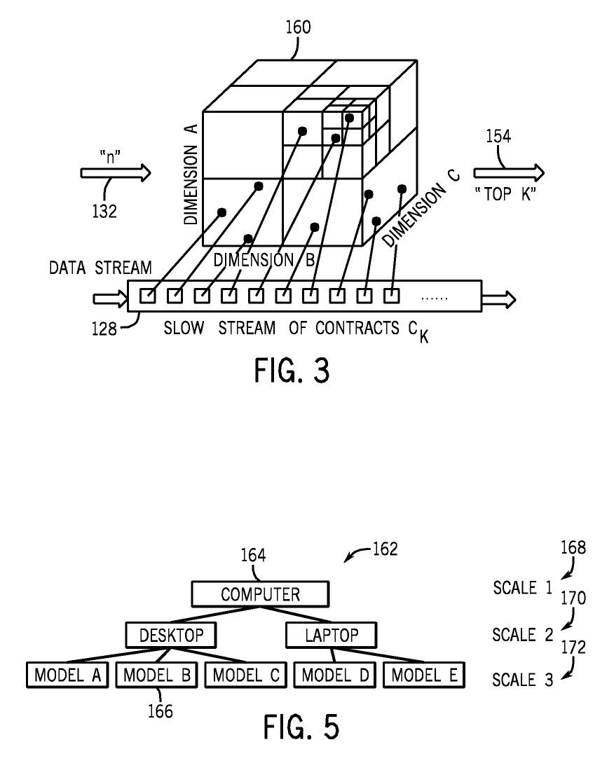

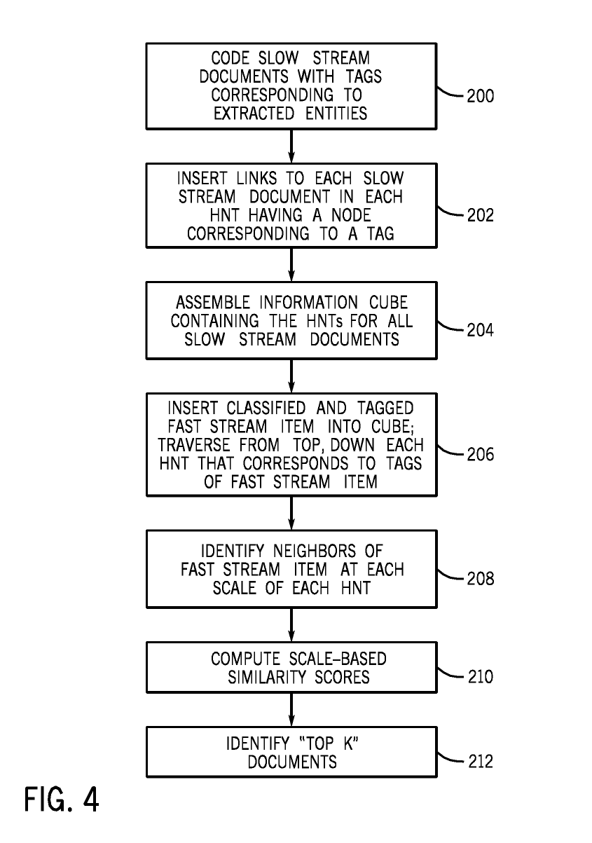

FIG. 3 provides a figurative exemplary representation of the overall correlation process, and FIG. 4 shows a corresponding exemplary flow diagram. As shown in FIG. 3, a slow stream of documents (e.g., contracts) 128 is inserted into an information or contract cube 160, which is implemented as a set of C-HNTs. When a fast stream 132 item (e.g., a news article) n streams into the cube 160, its neighbors (i.e., the contracts that the news article n affect) can be found using the information cube 160.

As previously discussed, and with reference to FIG. 4, the learned extraction models 126 are used to extract data from each item (e.g., contract) cₖ in the slow stream 128 and to create tags corresponding to the extracted data. The tags may then be used to code the slow stream 128 documents (block 200).

Each tag belongs to one or more predefined hierarchies. For example, “Mexico” is a tag in the “location” hierarchy. Each hierarchy has a corresponding C-HNT. An exemplary C-HNT 162 for the tag “computer” 164 is shown in FIG. 5. If we assume a contract cₖ that mentions Model B for a desktop computer, then a link to ck is inserted in the corresponding node 166 of the computer C-HNT 162. In doing so, the node 166 labeled “Model B” will contain links to all contracts that mention Model B.

This linking process is used to insert each item (e.g., contract) from the slow stream 128 into all the C-HNTs to which its tags belong (block 202 of FIG. 4). Continuing with the example used above, suppose the contract ck contains another tag on “date.” A link to the contract ck will then be inserted in a C-HNT corresponding to “date” at the appropriate node that corresponds to the value of the tag. Furthermore, if the tag having the value “Model B” belongs to multiple C-HNTs, then a link to it is inserted into each corresponding C-HNT at the node that corresponds to “Model B.”

Each node of a C-HNT defines a neighborhood and each level of a C-HNT (referred to as “scales”) defines the “tightness” of the neighborhood. For instance, referring to FIG. 4, C-HNT 162 has three levels 168, 170, 172. “Tightness” generally means that two objects that are objects at scale 2, for instance, but not at scale 3, have less in common than two objects that are neighbors at a lower depth (i.e., further from the root) in the hierarchical tree structure at scale 3. Here, “scale” is a numerical measurement corresponding to the level of a node in the C-HNT. The smaller the scale number, the closer the level is to the root (e.g., node 164) of the C-HNT and the less neighbors in the level have in common; and vice versa. The collection of all such C-HNTs for a particular item (e.g., contract) is referred to as a “cube” which represents the multiple dimensions (i.e., hierarchies) and the multiple abstraction levels (i.e., scales) at which the item exists.

Once the cube 160 is constructed from the slow stream 128 of information (e.g., the contracts that have been transformed into multidimensional points) (block 204), the cube 160 is ready for correlation. As previously discussed, at this stage, the classification models 124 have been used to classify the items (e.g., news articles) in the fast stream 132 into interesting and uninteresting categories. For each item in the interesting category 138, tags are obtained using the appropriate entity recognizers 142. To perform the correlation between the fast and slow streams 132, 128, only common hierarchies (i.e., common dimensions) are of interest. However, the set of tags (i.e., the values in each hierarchy) from the fast stream 132 items may be different from the set of tags from the cube 160 that has been constructed from the slow stream 128 of information. As previously discussed, additional tags (i.e., entities) can be inferred for the fast stream 132 items that are related to the slow stream 128 tags through the hierarchies. For example, a contract may not mention “Pacific region,” but it may refer to particular countries (e.g., “Philippines”). Nonetheless, these tags belong to the same hierarchy, i.e., the hierarchy for “location.” As a result, the C-HNT can correlate a contract (slow stream item) having a tag “Philippines” with a news article (fast stream item) having a tag “Pacific region” through the common ancestor (i.e., Pacific region).

Once the tags from the fast stream 132 items are obtained, each fast stream item nᵢ traverses each of the C-HNTs to which its tags belong (block 206). As nᵢ traverses each C-HNT, its slow stream neighbors cₖ at each scale are determined (block 208). This process is done in a top-down fashion. In this manner, the paths from the tags to the root of the C-HNTs are matched. Following the hierarchy of the tags, the level (i.e., scale) at which the fast stream item is “close” (i.e., a neighbor) to a slow stream item can be determined. Here, the definition of a neighbor is: if two points p and q belong to the same node n of a C-HNT, then the points are neighbors at the scale of node n. Since the root of a C-HNT corresponds to the “all” concept, all points are neighbors in the root node in the worst case. For example, in the “Philippines” and “Pacific region” case, the two points are neighbors (i.e., in the same node) at the scale of “Pacific region” since “Philippines” is a child node of “Pacific region.” The contents of nodes are nested from top-down. In other words, the “Pacific region” is the closest common ancestor.

C-HNTs thus provide a mechanism for quantifying the similarity between the slow stream 128 items and the fast stream 132 items. The smaller the scale at which the news item nᵢ and the contract cₖ are in the same node, the lower their similarity.

If a fast stream 132 item nᵢ and a slow stream 128 item cₖ are neighbors in multiple C-HNTs, they are considered even more similar.

A multi-dimension similarity can be composed using similarity over individual dimensions. For instance, in an exemplary embodiment, a multi-dimension similarity is computed by taking a minimum over all the dimensions. In this example, the minimum is taken after the depth for hierarchies in every dimension has been normalized between 0 and 1. That is, the scale 1 corresponding to the root node is normalized to a “0” depth and the maximum depth for the hierarchy in a given dimension is normalized to a “1” depth, with the intermediate scales being normalized between “0” and “1.” Thus, for instance, a hierarchical tree with a maximum depth of 2 (i.e., two scales) will have normalized depths of 0 and 1; a hierarchical tree with a maximum depth of 3 will have normalized depths of 0, ½ 1; a tree with a maximum depth of 4 will have normalized depths of 0, ⅓, ⅔, 1; and so forth.

A formula for normalizing the depths in this manner can be expressed as follows:

let the maximum depth be max_depth,then

for max_depth=2,the normalized depths are 0,1;

for max_depth>2,the normalized depths are

i=0 . . . max_depth−1:i/(max_depth−1)

The foregoing technique for computing multi-dimension similarity has been provided as an example only. It should be understood that other embodiments of the techniques and systems described herein may determine similarity differently and/or combine similarity from multiple dimensions in other manners. It should further be noted that the calculated similarity is relative and, thus, comparable only with other similarities having the same dimensions.

Once similarity has been computed (such as by using the normalization technique described above) (block 210), the “top k” contracts that are affected by the news item n can be determined (block 212), as will be explained in further detail below.

The C-HNT is the primary data structure used for the contract cube correlation. The common tags for the contracts and the news items are all considered categorical data. There are three basic operations that the C-HNT supports for the incremental maintenance of the contract cube: insertion, deletion, and finding the “top k” contracts. In the following discussion, each incoming news article n is treated as one multi-dimensional data point with every tag in an independent dimension.

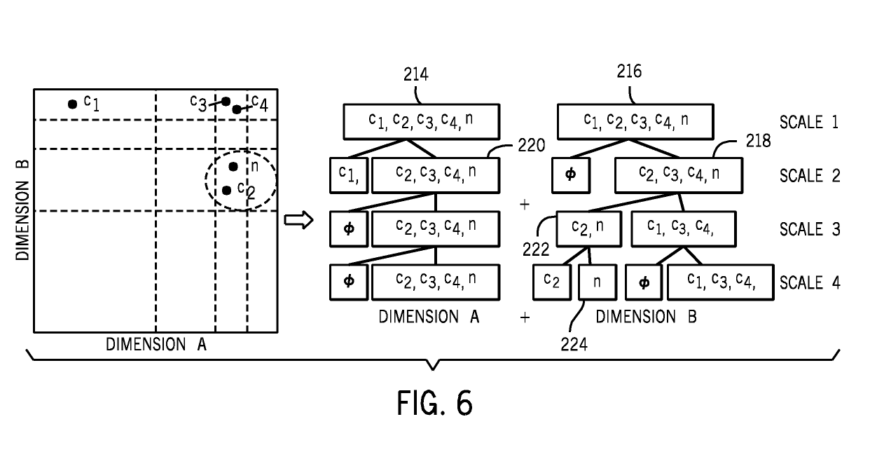

Insertion. When a news article n enters the window under consideration in the fast stream 132, the news article n is inserted in each of the nodes in the C-HNTs that correspond to its tags. Such a process is shown in FIG. 6, wherein point n is inserted in the appropriate levels (scales) in dimensions A and B. Here, we assume dimensions A and B are two tag dimensions. FIG. 6 also helps to explain how neighbors of point n are interpreted and similarity determined. For example, at scale 1, all the contract points are neighbors of n in node 214 of dimension A and node 216 of dimension B. At scale 2, for dimension B, points [c1; c2; c3; c4] are still neighbors of n in node 218, but for dimension A, n's neighborhood has changed to [c1; c2; c3] in node 220. At scale 3 in dimension B, point n has only one neighbor c2 in node 222. At scale 4 in dimension B, point n has no neighbors. In this manner, similarity scores between news item n and the various documents cₖ may be determined using the C-HNT structure. The similarity scores may then be used to determine a set of documents that are most affected (i.e., are most similar to) the news item n. This set of documents is referred to as a “top k list.”

Finding the “top k.” To find the “top k” list, similarity scores of the news article n with each document cₖ in the cube are calculated. By sorting the similarity scores, the top k documents cₖ that are affected by the new article n can be identified.

In some embodiments, particularly where the information cube 160 is particularly large, this brute force method of identifying the top k documents may not be particularly efficient. Thus, specific search paths may be used to extend the neighborhood of an effective region of a news article n. In such embodiments, only those documents that fall within the extended neighborhood are considered in identifying the top k documents. The effective region may be iteratively expanded until enough candidate contracts are available for consideration as the top k documents.

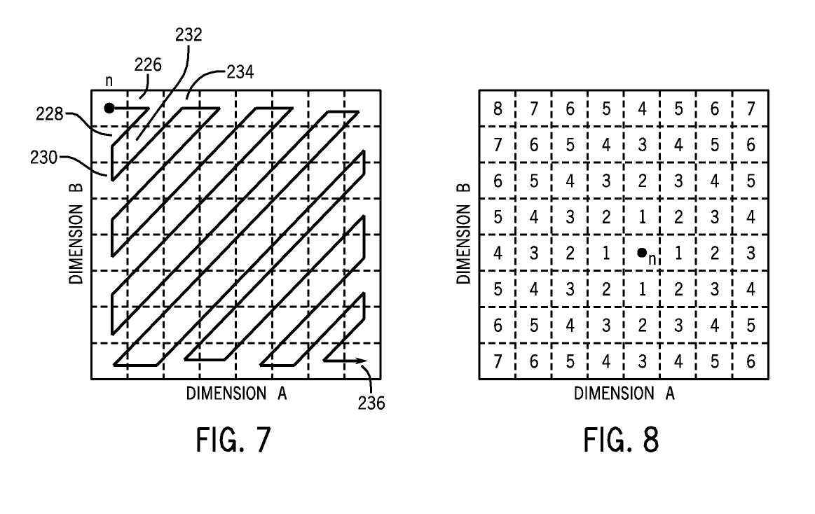

Examples of specified search paths for iteratively extending the neighborhood of an effective region of an item n is illustrated in FIGS. 7 and 8. In FIG. 7, the point n is in a corner. In a first pass, the neighborhood is expanded to include blocks 226 and 228; in a second pass, the neighborhood is further expanded to include blocks 230, 232, and 234; and so forth. The search terminates either when a sufficient number of documents have been identified or when the search reaches the final block 236.

In FIG. 8, the point n is in a central position. In a first pass, the neighborhood is expanded to include the four blocks labeled with “1”; in a second pass, the neighborhood is expanded to further include the blocks labeled with “2”; and so forth until either a sufficient number of documents are identified as top k candidates or all blocks have been searched.

Deletion. Each news article is assumed to have a valid period after which its effect is revoked by removing it from all corresponding C-HNTs. Removing a news article from the corresponding C-HNTs generally follows a reverse process of the insertion. That is, the neighbor documents in the information cube are identified and removed from the current top k list.

Optimizations. In some embodiments, various techniques may be implemented to optimize end-to-end data flow by considering tradeoffs between different quality metrics. Such techniques may be implemented within any of the various phases discussed above that are performed on-line (i.e., in real-time or near-real-time). For instance, during the model application phase, data extraction may be optimized in various ways, including having available different entity recognizers of different accuracies and efficiencies for each entity type. In such embodiments, an appropriate entity recognizer can be selected based on the current quality requirements. For instance, if accuracy is more important than speed, then a highly accurate recognizer may be selected.

As another example, tuning knobs may be introduced into the extraction algorithms that dynamically tune them according to the quality requirements. For example, if efficiency is the priority, then a genetic-type extraction algorithm can be set to execute fewer iterations so that it runs more quickly, but perhaps less accurately. Another optimization technique may be to use a version of the extraction algorithm that does not employ PoS tagging.

With respect to the streaming analytics phase, the tradeoff that should be considered is between the accuracy of the correlation and the efficiency needed to cope with the high rate at which items in the fast stream arrive. For large volumes of streaming information items, one possible optimization is to consider only a sample of arriving items. For instance, typically multiple news articles will be related to the same topic. Thus, the news items may be randomly sampled before finding neighbors using the C-HNTs. This technique can provide an immediate tradeoff between accuracy and efficiency.

As another example of an optimization in the analytics phase, if sampling is not sufficient to cope with large volume streams, then only a subset of the C-HNTs to which a news article belong may be considered. A yet further option may be to reduce the maximum depth of the hierarchy, which can limit the traversal time and the number of identified neighbors.

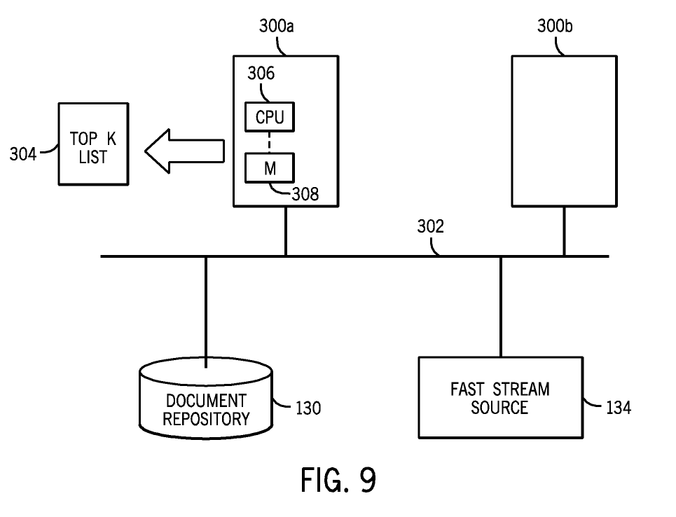

FIG. 9 illustrates an exemplary architecture in which the correlation systems and techniques described above may be implemented. Referring to FIG. 9, as a non-limiting example, the systems and techniques that are disclosed herein may be implemented on an architecture that includes one or multiple physical machines 300 (physical machines 300a and 300b, being depicted in FIG. 9, as examples). In this context, a “physical machine” indicates that the machine is an actual machine made up of executable program instructions and hardware. Examples of physical machines include computers (e.g., application servers, storage servers, web servers, etc.), communications modules (e.g., switches, routers, etc.) and other types of machines. The physical machines may be located within one cabinet (or rack); or alternatively, the physical machines may be located in multiple cabinets (or racks).

As shown in FIG. 9, the physical machines 300 may be interconnected by a network 302. Examples of the network 302 include a local area network (LAN), a wide area network (WAN), the Internet, or any other type of communications link, and combinations thereof. The network 302 may also include system buses or other fast interconnects.

In accordance with a specific example described herein, one of the physical machines 300a contains machine executable program instructions and hardware that executes these instructions for purposes of defining and learning model, receiving slow and fast streams of information, applying the learned models, classifying items and extracting entities, generating tags, performing C-HNT-based correlations and computing similarity scores, identifying a top k list, etc. Towards that end, the physical machine 300a may be coupled to a document repository 130 and to a streaming information source 134 via the network 302.

The processing by the physical machine 300a results in data indicative of similarity between slow stream 128 documents and fast stream 132 items, which can be used to generate a top k list 304 of slow stream 128 documents that are affected by the fast stream 132 items.

Instructions of software described above (including the techniques of FIGS. 1 and 4, and the various learning, extraction, recognition algorithms, etc. described above) are loaded for execution on a processor (such as one or multiple CPUs 306 in FIG. 9). A processor can include a microprocessor, microcontroller, processor module or subsystem, programmable integrated circuit, programmable gate array, or another control or computing device. As used here, a “processor” can refer to a single component or to plural components (e.g., one CPU or multiple CPUs).

Data and instructions are stored in respective storage devices (such as one or multiple memory device 308 in FIG. 9) which are implemented as one or more non-transitory computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method, comprising:
extracting first entities from documents received by a processor-based machine in a slow stream;
extracting second entities from current information items received by the processor-based machine in a fast stream;
performing, by the processor-based machine, a correlation using the extracted first entities and extracted the second entities to determine similarities between the documents and the current information items; and
based on the similarities, identifying a set of documents items affected by the current information items.

2. The method as recited in claim 1, wherein the correlation is performed in real time or near real time with receipt of the fast stream of information.

3. The method as recited in claim 1, further comprising:
providing a plurality of hierarchical neighborhood trees (HNTs), each HNT having a plurality of nodes corresponding to related entities, the nodes arranged in a hierarchical structure in accordance with relationships among the related entities,
wherein performing the correlation comprises:
linking the documents to nodes in HNTs corresponding to the first entities extracted from the documents; and
linking the current information items to nodes in HNTs corresponding to the second entities extracted from the current information items to identify documents that are neighbors of each current information item.

4. The method as recited in claim 3, wherein each hierarchical structure includes a plurality of levels in which the nodes are arranged, and wherein similarities are determined based, in part, on depth of the levels at which the neighbors are located.

5. The method as recited in claim 1, further comprising:
correlating the current information items with information items received within a time window in the fast stream previous to the current information items; and
determining reliabilities of the current information items based on the correlation, wherein determining the similarities between the documents and the current information items is further based on the reliabilities.

6. The method as recited in claim 1, further comprising:
classifying the current information items received in the fast stream into interesting and non-interesting categories, and
extracting the second entities only from current information items classified into an interesting category.

7. The method as recited in claim 6, wherein the first entities are role-based entities.

8. The method as recited in claim 3, wherein identifying the set of documents comprises iteratively expanding the neighborhoods of the current information items in the HNTs until a predefined number of similar documents is identified.

9. The method recited in claim 3, further comprising:
deleting a first current information item from its corresponding HNTs after a predefined period of time; and
removing documents that were neighbors of the first current information item from the set of documents.

10. An apparatus, comprising:
a first data extractor to extract first data entities from a collection of static information items;
a second data extractor to extract second data entities from a current information item arriving in a fast stream of information; and
a processor-based correlator to determine degrees of similarity between the static information items and the current information item based on the extracted first data entities and the extracted second data entities and, based on the degrees of similarity, to identify a set of static information items that are most affected by the current information item.

11. The apparatus as recited in claim 10, wherein the processor-based correlator determines the degrees of similarity in real time or near-real time with arrival of the fast stream.

12. The apparatus as recited in claim 10, further comprising:
a hierarchical neighborhood tree (HNT) constructor to construct a plurality of HNTs, each HNT including a plurality of nodes corresponding to related data entities, the nodes arranged in a hierarchical structure in accordance with relationships among the related data entities, wherein a node includes a reference to a static document from the collection if the node corresponds to an extracted first data entity,
wherein the processor-based correlator determines degrees of similarity by identifying static documents in the collection that are neighbors in the HNTs of the current information item, wherein a particular static document is a neighbor if the particular static document and the current information item share a common node in an HNT

13. The system as recited in claim 12, wherein each hierarchical structure includes a plurality of levels in which the nodes are arranged, and wherein the processor-based correlator determines degrees of similarity based on depth of the levels in which the neighbors are located.

14. The system as recited in claim 11, wherein the processor-based correlator further correlates the current information item with previous information items in the fast stream to determine reliability of the current information items wherein the processor-based correlator determines the similarities further based on the reliability.

15. The system as recited in claim 11, wherein the processor-based correlator outputs similarity scores corresponding to the similarities for identification of a set of static documents in the collection that are most affected by the current new items.

16. An article comprising a non-transitory computer readable storage medium to store instructions that when executed by a computer cause the computer to:
correlate a collection of documents with an information item provided in a fast stream of information by:
inserting first data entities extracted from the documents into hierarchical data structures;
determining first data entities that are neighbors in the hierarchical data structures of second data entities extracted from the information; and
determining similarities between the collection of documents and the information item based on the locations in the hierarchical data structures of the neighbors.

17. The article as recited in claim 16, the storage medium storing instructions that when executed by the computer cause the computer to:
extract the first data entities from the documents; and
extract second data entities from a plurality of information items provided in the fast stream.

18. The article as recited in claim 17, the storage medium storing instructions that when executed by the computer cause the computer to classify the information items into interesting and uninteresting categories, and to extract second data entities only from the information items classified into the interesting categories.

19. The article as recited in claim 17, the storage medium storing instructions that when executed by the computer cause the computer to correlate second data entities extracted during a first time window in the fast stream with second data entities extracted during a second time window in the fast stream to determine reliability of the information items.

20. The article as recited in claim 19, wherein the similarities are further based on the determined reliability.
